(19) United States
(12) Patent Application Publication
(10) Pub. No.: US 2009/0058874 A1
(43) Pub. Date: Mar. 5, 2009

(54) IMAGE DISPLAY DEVICE

(76) Inventors: Maiko Takenaka, Kanagawa (JP); Taku Kodama, Kanagawa (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/200,672

(22) Filed: Aug. 28, 2008

(30) Foreign Application Priority Data
Aug. 28, 2007 (JP) 2007-221517

(51) Int. Cl. G09G 5/02

(52) U.S. Cl. 345/589

(57) ABSTRACT

A first data storing unit stores therein first data required for displaying an image in a drawing window. Upon a mode switching unit switching a display mode in the drawing window, a data acquiring unit acquires auxiliary data required for displaying the image in a switched display mode from the first data storing unit. A data generating unit generates image data required for displaying the image in the switched display mode using the auxiliary data. A displaying unit displays thereon the image in the switched display mode in drawing window using the image data generated by the data generating unit.

### CROSS-REFERENCE TO RELATED APPLICATIONS

The present application claims priority to and incorporates by reference the entire contents of Japanese priority document 2007-221517, filed in Japan on Aug. 28, 2007.

### BACKGROUND OF THE INVENTION

1. Field of the Invention

The present invention relates to a technology for displaying an image in response to a display request from a user.

2. Description of the Related Art

Images are electronically displayed by image display devices such as personal computers having browsers. Typical image display devices are configured to acquire image data of an image to be displayed from various data stored in personal computers or servers and display the image of acquired image data. Some image display devices have functions for switching a display mode between a color mode and a monochrome mode for each image to be displayed.

A conventional technology for converting image data between color data and monochrome data for each image is disclosed in, for example, Japanese Patent Application Laid-open No. 2002-244969. In this technology, a server is configured to convert image data of an image between a color data and a monochrome data based on a display request from a user, and send converted image data to an image display device. Thereby, the image display device can display images in a requested color mode. Furthermore, Japanese Patent Application Laid-open No. 2005-262766 discloses a conventional technology for switching a display mode of an image from a color mode to a monochrome mode with respect to each page. Specifically, an image display device is configured to convert color data to monochrome data with respect to each page that contains an image requested from a user, and display the image of converted monochrome data on a display screen.

However, in the former conventional technology, the server needs to store therein both color image data and monochrome image data. Therefore, large storage capacity is required in the server.

In the latter conventional technology, a page containing a target image for a monochrome conversion is subjected to a series of processing including compression processing, monochrome conversion processing, and expansion processing. In this technology, because a display mode is switched with respect to each page, image data of an entire image in a target page are converted from color data to monochrome data. Therefore, the amount of image data to be processed increases, as the size of the target page increases. As a result, long processing time is required.

Furthermore, the above conventional technologies are not developed for converting image data of only an image that is displayed in a drawing window of an image display device. That is, even when only a part of an image is displayed in the drawing window and color conversion is requested only to the part of the image, the entire image including other parts not displayed in the drawing window is subjected to expansion processing, and then the part of the image is displayed in the drawing window.

Because other parts excluded from a target part of the image are also subjected to conversion processing, extra processing time is required. Meanwhile, performing expansion processing on only a target part that is displayed in the drawing window can be one countermeasure. FIG. 20 is a schematic diagram of a display screen of a conventional image display device, in which a part of an image is displayed. In FIG. 20, a thin-line square depicts the entire image and a thick-line square depicts the drawing window with the part of the image. That is, a part of a color image is displayed in the drawing window. At this state, if the drawing window is scrolled and monochrome conversion is performed on an image in a scrolled drawing window, the image is displayed in the manner shown in FIG. 21. That is, a monochrome image is displayed only in the scrolled drawing window. In this state, when the drawing window is scrolled back to a previous position as shown in FIG. 22, the part of the color image is displayed in the drawing window as shown in FIG. 20. Thus, a color part and a monochrome part are disadvantageously mixed in a single image.

Therefore, if the drawing window is scrolled to the right while the color part is displayed as shown in FIG. 20, another color part of the image is displayed in the scrolled drawing window as shown in FIG. 23. Then, if monochrome conversion is performed on the image in the scrolled drawing window shown in FIG. 23, only the part displayed in the scrolled drawing window is converted to a monochrome image as shown in FIG. 21. Thus, a color part and a monochrome part are disadvantageously mixed in a single image.

### SUMMARY OF THE INVENTION

It is an object of the present invention to at least partially solve the problems in the conventional technology.

According to an aspect of the present invention, there is provided an image display device that displays at least a part of an image in a drawing window. The image display device includes a first data storing unit that stores therein first data required for displaying the image in the drawing window; a mode switching unit that switches a display mode in the drawing window; a data acquiring unit that acquires, upon the mode switching unit switching the display mode, auxiliary data required for displaying the image in a switched display mode in the drawing window from the first data storing unit; a data generating unit that generates image data required for displaying the image in the switched display mode in the drawing window using the auxiliary data acquired by the data acquiring unit; and a displaying unit that displays the image in the switched display mode in drawing window using the image data generated by the data generating unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an image display device according to a first embodiment of the present invention;

FIG. 2 is a schematic diagram of a hardware configuration of the image display device shown in FIG. 1;

FIG. 3 is a flowchart of a display switching process performed by the image display device shown in FIG. 1;

FIGS. 4A and 4B are schematic diagrams of display screens of the image display device shown in FIG. 1;

FIG. 5 is a flowchart of another display switching process performed by the image display device shown in FIG. 1;

FIG. 6 is a flowchart of a display switching process performed by an image display device according to a second embodiment of the present invention;

FIGS. 7 to 12 are schematic diagrams of display screens of the image display device according to the second embodiment;

FIG. 13 is a flowchart of a display switching process performed by an image display device according to a third embodiment of the present invention;

FIGS. 14 to 19 are schematic diagrams of display screens of the image display device according to the third embodiment; and

FIGS. 20 to 23 are schematic diagrams of display screens of a conventional image display device.

### DETAILED DESCRIPTION OF THE PREFERRED EMBODIMENTS

Exemplary embodiments of the present invention are explained in detail below with reference to the accompanying drawings. The present invention is not limited to the following embodiments. Various modifications can be made without departing from the scope of the present invention.

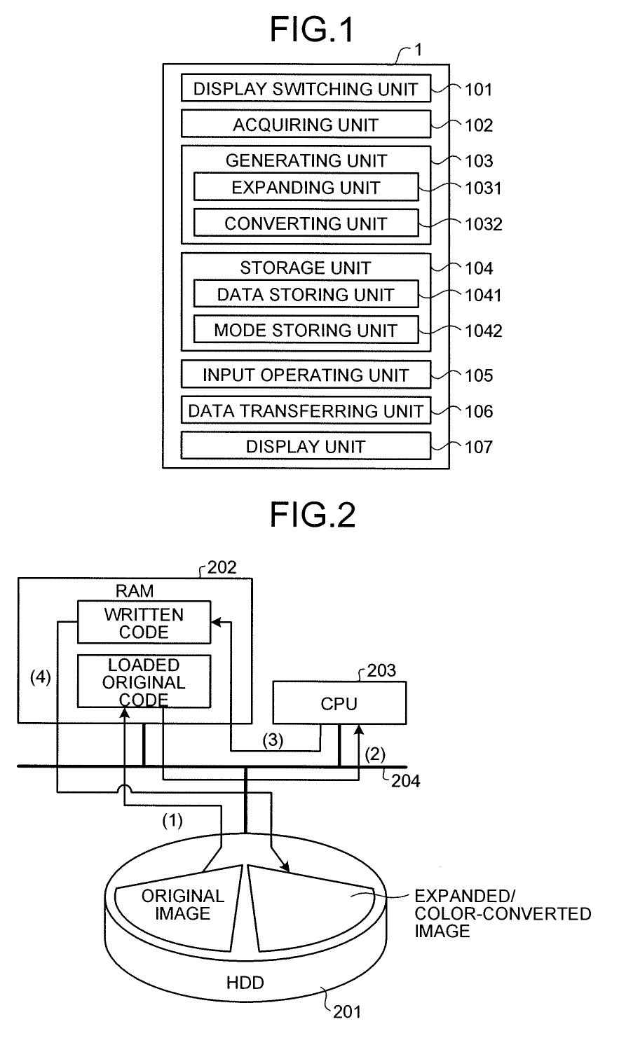

FIG. 1 is a functional block diagram of an image display device 1 according to a first embodiment of the present invention, in which application software that runs a display switching process is installed. It is assumed that the image display device 1 is implemented by a personal computer (PC).

The image display device 1 includes a display switching unit 101, an acquiring unit 102, a generating unit 103, a storage unit 104, an input operating unit 105, a data transferring unit 106, and a display unit 107. The generating unit 103 includes an expanding unit 1031 and a converting unit 1032. The storage unit 104 includes a data storing unit 1041 and a mode storing unit 1042. The image display device 1 also includes other units that execute image processing; however, the other units are not related to the present invention. Therefore, only the units shown in FIG. 1 are explained below.

The display switching unit 101 switches a display mode of a drawing window. Specifically, the display switching unit 101 receives image-display switching request information from the input operating unit 105. The image-display switching request information indicates switching of a display mode of a drawing window of the display unit 107 between a color mode and a monochrome mode and is issued in response to an input operation by a user using a keyboard. The display switching unit 101 then determines a mode based on the information. Furthermore, the display switching unit 101 determines whether the image-display switching request information indicates scroll operation, zoom-in operation, zoom-out operation, or the like. Thus, the image-display switching request information is a request from a user for switching a display of an image in the drawing window.

The display switching unit 101 converts the image-display switching request information received from a user into information that indicates a target image name or a drawing window size, and then sends converted information as request information to the acquiring unit 102. The request information is information that indicates conditions for switching a display of an image in the drawing window. That is, a size of the drawing window can be changed to a desired size by clicking or dragging of the drawing window by a mouse. In this case, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user.

For specifying a requested image area (for specifying an image area requested by a display request that indicates scroll operation, zoom-in operation, or zoom-out operation), information on image name, image size, drawing window size of a requested area, and offset value is used. The generating unit 103 generates image data and the data transferring unit 106 transfers the image data, and thereby an image of the image data is displayed in the drawing window.

Thus, the display switching unit 101 serves as a request information generating unit that generates the request information based on the image-display switching request information. Furthermore, the display switching unit 101 performs control to display an image of the image data generated by the generating unit 103 and transferred by the data transferring unit 106 in the display unit 107.

The acquiring unit 102 acquires missing data from the data storing unit 1041 based on the request information from the display switching unit 101. The missing data is data that is part of data necessary for generating an image to be displayed on the drawing window and not yet acquired. For example, when a display mode is switched from the monochrome mode to the color mode, color-difference data (Cb and Cr data) is missing and need to be acquired. A determination whether there is missing data can be made by, for example, determining whether data in the area specified by drawing-window specifying information is color data, luminance data, or data of default value. The data to be acquired is code data contained in the image data in the drawing window.

The generating unit 103 generates image data of an image to be displayed in the drawing window from the data acquired by the acquiring unit 102. The expanding unit 1031 expands acquired code data. The converting unit 1032 performs color conversion on bitmap data depending on a mode. The color conversion is performed on the bitmap data such that, when the display mode is switched from the color mode to the monochrome mode, the color data is converted into the luminance/color-difference data (Y, Cb, and Cr data) and then only the luminance data (Y data) is extracted. The converting unit 1032 converts color-converted data to a data in a mode different from a mode displayed in the drawing window of before display-mode switching. Furthermore, the converting unit 1032 performs color conversion on expanded luminance/color-difference data such that the luminance/color-difference data (Y, Cb, and Cr data) is converted into color data (RGB data) based on the following color conversion equation.

Y=(2G+R+B)/4

Cb=B−G

Cr=R−G

The storage unit 104 stores therein data necessary for displaying an image in the drawing window. The data storing unit 1041 stores code data (compressed data of the entire image) that is to be a target image and input in advance. The target image is an image to be acquired by the acquiring unit 102. The target image is, for example, a JPEG2000 image. In such a case, images in other formats are converted into the JPEG2000 image. A technology for performing encoding processing on JPEG2000 images is disclosed in, for example, Japanese Patent Application Laid-open No. 2006-196968.

The data storing unit 1041 stores bitmap data, expanded data, or color-converted data, of the entire image. Furthermore, the data storing unit 1041 stores data that is displayed in the drawing window before display-mode switching.

In the first embodiment, the data storage unit that stores therein the code data input in advance is provided in the PC. However, the code data can be stored in a server such that the code data is sent from the server to the acquiring unit 102 in response to a request from the PC.

The acquiring unit 102 acquires information on image-frame size specification, drawing-window area size, and drawing-window area offset specification in response to a drawing window request from the display switching unit 101. The acquiring unit 102 changes required parameter value based on an actual size of the target image. Then, the data storing unit 1041 returns code data corresponding to a changed parameter value to the acquiring unit 102 in response to the request from the acquiring unit 102.

The mode storing unit 1042 stores a retention mode and a mode that is displayed in the drawing window before display-mode switching. Furthermore, the mode storing unit 1042 updates the display mode of before display-mode switching to a mode of after display-mode switching with respect to the image displayed in the drawing window.

The input operating unit 105 includes a keyboard and the like, performs display-mode switching operation, zoom operation, and the like in response to input operation from the keyboard, and sends operation information to the display switching unit 101. The data transferring unit 106 transfers data that is expanded by the expanding unit 1031 and converted by the converting unit 1032 to the display switching unit 101.

FIG. 2 is a schematic diagram of a hardware configuration of the image display device 1. An HDD 201, a RAM 202 (set in the PC), and a CPU 203 (set in the PC) are connected to one another via a data bus 204. Original codes are subjected to expansion processing and color conversion processing while expanded data are subjected to color conversion processing in the following procedure.
(1) Original code or expanded data stored in the HDD 201 is loaded on the RAM 202 in response to a command from the CPU 203.
(2) The CPU 203 reads the code from the RAM 202 and performs expansion processing and color conversion processing. Furthermore, the CPU 203 reads the expanded data from the RAM 202 and performs color conversion processing.
(3) The CPU 203 writes the expanded/color-converted data or color-converted data to another area (different from a data-loaded area) of the RAM 202.
(4) The expanded/color-converted data or color-converted data are recorded in the HDD 201 in response to a command from the CPU 203.

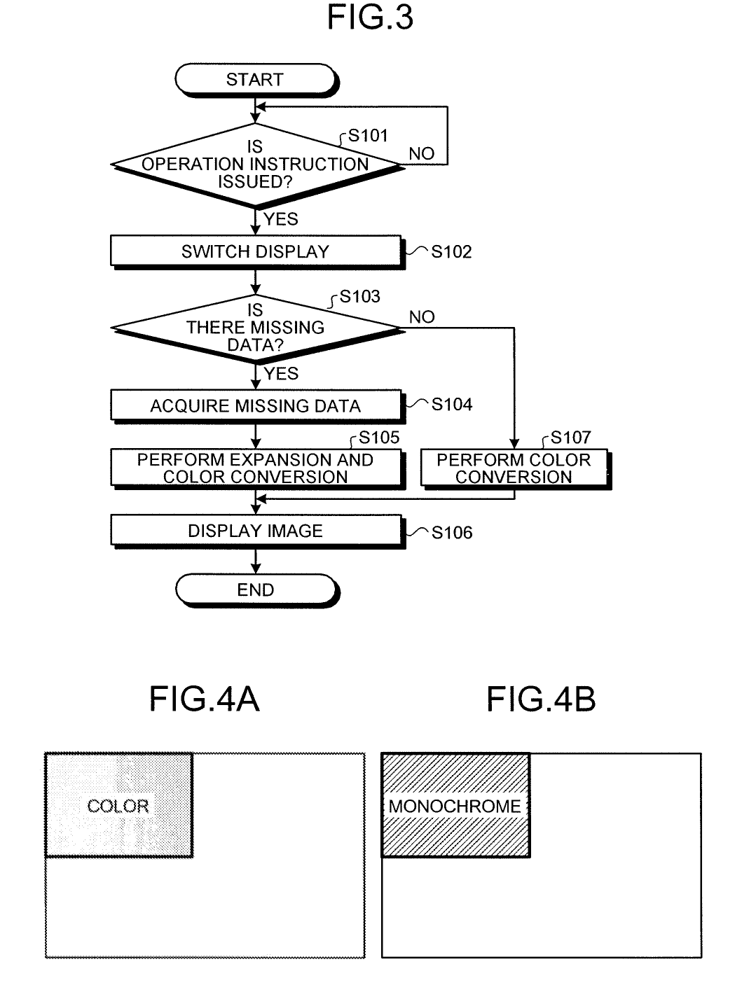

FIG. 3 is a flowchart of a display switching process performed by the image display device 1. Assuming that a part of a color image (hereinafter, referred to as “partial image” as appropriate) is displayed in the entire drawing window of the display device as shown in FIG. 4A. The drawing window size can be changed to a desired size by clicking or dragging of the drawing window. In this state, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. The changed information is used as the request information.

Upon displaying, the bitmap data of the entire image is stored. In the bitmap data, data is contained in a partial image that is displayed in the drawing window and default values are contained in other parts of the image (other than the partial image). In this example, a color image is displayed, and thereby the bitmap data is stored such that color data is contained in the entire bitmap data. On the other hand, when a monochrome image is displayed, the bitmap data is stored such that luminance data is contained in the entire bitmap data.

A process for switching a display mode from the color mode as shown in FIG. 4A to the monochrome mode as shown in FIG. 4B is described below. The switching operation to the monochrome mode is performed in response to input operation by the input operating unit 105.

The display switching unit 101 determines whether the image-display switching request information is issued as an operation instruction from a user (Step S101). When the operation instruction (the image-display switching request information) is not issued (No at Step S101), the display switching unit 101 awaits the operation instruction (the image-display switching request information).

When the operation instruction (the image-display switching request information) is issued (Yes at Step S101), the display switching unit 101 changes display condition information for performing image display so that display switching (in this example, switching to the monochrome mode) instructed by the operation instruction (the image-display switching request information) is performed (Step S102). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. The changed information is sent as the request information to the acquiring unit 102 and used for acquiring code data.

The acquiring unit 102 determines whether there is missing data that need to be acquired to perform display-mode switching with image data of a currently-displayed image (Step S103). Upon switching from the color mode to the monochrome mode, monochrome mode can be obtained by converting color data (RGB data) contained in the bitmap data currently displayed in the drawing window into luminance/color-difference data (Y, Cb, and Cr data), and then extracting only luminance data (Y data). Therefore, the missing data is not present.

On the other hand, upon switching from the monochrome mode to the color mode, color-difference data (Cb and Cr data) is missing and need to be acquired. A determination whether there is missing data can be made by, for example, determining whether data in the area specified by drawing-window specifying information is color data, luminance data, or data of default value. Other determination methods are also applicable. In this example, it is determined that the missing data is not present because the display mode is switched from the color mode to the monochrome mode (No at Step S103). Then, process control proceeds to Step S107.

The converting unit 1032 performs color conversion on the bitmap data (Step S107). Specifically, the color data is converted into the luminance/color-difference data and then only luminance data is extracted. The display unit 107 displays an image of extracted data in the drawing window (Step S106). Thus, a display mode is switched from the color mode shown in FIG. 4A to the monochrome mode shown in FIG. 4B.

In the above example, the color data is converted into the luminance/color-difference data and only luminance data is extracted, thereby an image of the extracted luminance data is displayed. On the other hand, when it is determined that there is the missing data (Yes at Step S103), the acquiring unit 102 acquires luminance data of an image to be displayed in the drawing window from the data storing unit 1041 (Step S104). Then, the expanding unit 1031 expands the acquired data (Step S105) and an image of the expanded data is displayed in the drawing window (Step S106).

A process for switching a display mode from the monochrome mode shown in FIG. 4B to the color mode shown in FIG. 4A is described below. The display switching unit 101 determines whether the image-display switching request information is issued as an operation instruction from a user (Step S101). When the operation instruction (the image-display switching request information) is not issued (No at Step S101), the display switching unit 101 awaits the operation instruction (the image-display switching request information).

When the operation instruction (the image-display switching request information) is issued (Yes at Step S101), the display switching unit 101 changes display condition information for performing image display so that display switching (in this example, switching to the monochrome mode) instructed by the operation instruction (the image-display switching request information) is performed (Step S102). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. The changed information is sent as the request information to the acquiring unit 102 and used for acquiring code data.

The acquiring unit 102 determines whether there is missing data that need to be acquired to perform display-mode switching with image data of a currently-displayed image (Step S103). In this example, it is determined that color-difference data (Cb and Cr data) is missing because the display mode is switched from the monochrome mode to the color mode (Yes at Step S103). Then, process control proceeds to Step S104.

The acquiring unit 102 acquires, as the missing data, the color-difference data of an image (a part of the entire image) to be displayed in the drawing window from the data storing unit 1041 based on the request information (Step S104). The expanding unit 1031 expands acquired data and the converting unit 1032 performs color conversion on expanded data (Step S105). Then, the display unit 107 displays an image of expanded data in the drawing window (Step S106). Thus, a display mode is switched from the monochrome mode shown in FIG. 4B to the color mode shown in FIG. 4A.

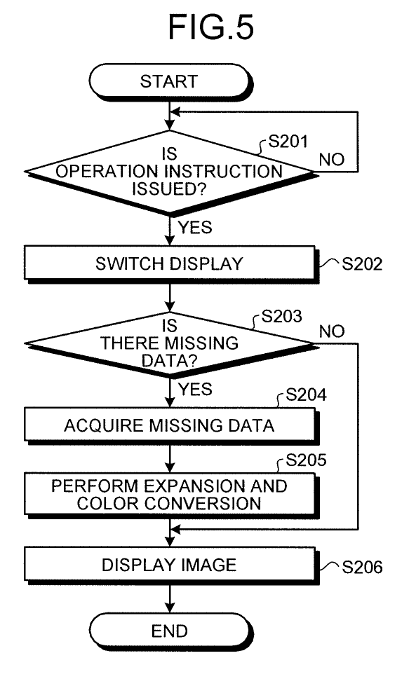

FIG. 5 is a flowchart of another display switching process performed by the image display device 1. A process for performing zoom-in operation on the monochrome image shown in FIG. 4B is described below. The display switching unit 101 determines whether the image-display switching request information is issued as an operation instruction from a user (Step S201). When the operation instruction (the image-display switching request information) is not issued (No at Step S201), the display switching unit 101 awaits the operation instruction (the image-display switching request information).

When the operation instruction (the image-display switching request information) is issued (Yes at Step S201), the display switching unit 101 changes display condition information for performing image display so that display switching (in this example, zoom-in operation) instructed by the operation instruction (the image-display switching request information) is performed (Step S202). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. Furthermore, resolution information is changed. The changed information is sent as the request information to the acquiring unit 102 and used for acquiring code data.

The acquiring unit 102 determines whether there is missing data that need to be acquired to perform display-mode switching with image data of a currently-displayed image (Step S203). A determination whether there is missing data can be made by, for example, comparing resolution of data in an area specified by drawing-window specifying information with resolution specified by the drawing-window specifying information. Other determination methods are also applicable. For performing zoom-in operation, data with resolution higher than that of currently-displayed data is necessary. Therefore, it is determined that there is the missing data (Yes at Step S203). Then, process control proceeds to Step S204.

The acquiring unit 102 acquires, as the missing data, data with high resolution corresponding to an image (a part of the entire image) to be displayed in the drawing window from the data storing unit 1041 based on the request information (Step S204). The data with high resolution is acquired with respect to an image area to be displayed in the drawing window after zoom-in operation. Then, the expanding unit 1031 expands acquired data and color conversion from luminance/color-difference data into color data is performed (Step S205). The color conversion is performed such that the luminance/color-difference data (Y, Cb, and Cr data) is converted into color data (RGB data) based on the following color conversion equation.

G=Y−(Cb+Cr)/4

R=Cr+G

B=Cb+G

Then, the display unit 107 displays an image of converted data in the drawing window (Step S206).

A process for performing zoom-out operation is described below. The display switching unit 101 determines whether the image-display switching request information is issued as an operation instruction from a user (Step S201). When the operation instruction (the image-display switching request information) is not issued (No at Step S201), the display switching unit 101 awaits the operation instruction (the image-display switching request information).

When the operation instruction (the image-display switching request information) is issued (Yes at Step S201), the display switching unit 101 changes display condition information for performing image display so that display switching (in this example, zoom-out operation) instructed by the operation instruction (the image-display switching request information) is performed (Step S202). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. Furthermore, resolution information is changed. The changed information is sent as the request information to the acquiring unit 102 and used for acquiring code data.

The acquiring unit 102 determines whether there is missing data that need to be acquired to perform display-mode switching with image data of a currently-displayed image (Step S203). For performing zoom-out operation, data with resolution lower than that of currently-displayed data is used. Therefore, it is determined that the missing data is not present (No at Step S203). Then, process control proceeds to Step S206. The display unit 107 displays an image of converted data in the drawing window (Step S206).

In the above examples, zoom operation is performed on a monochrome image. However, zoom operation can be performed in the same manner on a color image.

As described above, the image display device 1 can perform image display processing at high processing speed by expanding only an image part to be displayed in the drawing window. Furthermore, the image display device 1 can handle a display-mode switching operation and a zooming operation. Therefore, it is possible to display an image without mixing a monochrome part and a color part in the drawing window even when scroll operation or display-mode switching operation between the color mode and the monochrome mode is performed.

In the above example, the display-mode switching is performed on an image that is displayed in the drawing window of the image display device 1 as shown in FIGS. 4A and 4B. However, the same display-mode switching can be performed to an image in a size smaller than the size of the drawing window.

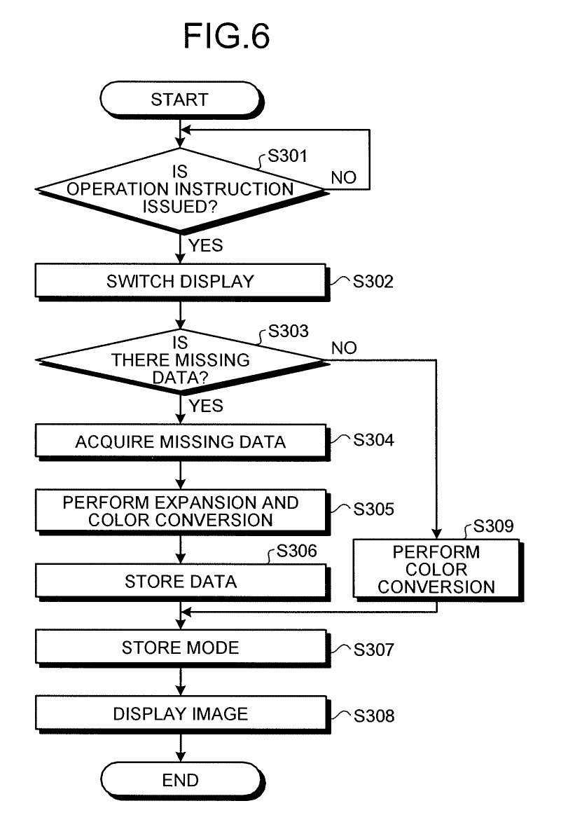

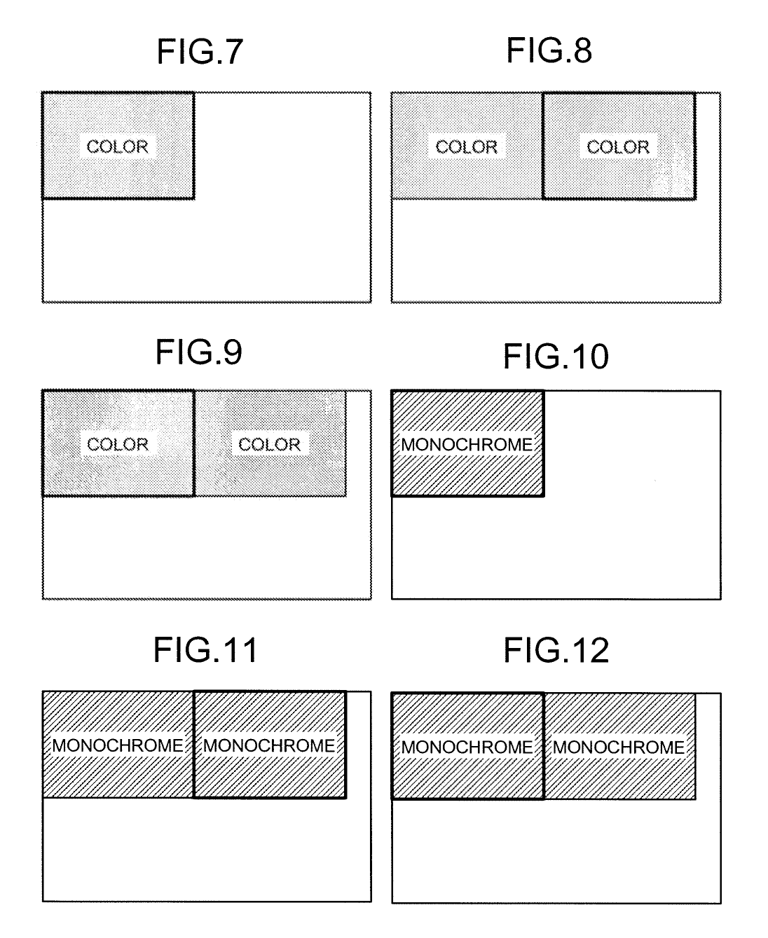

FIG. 6 is a flowchart of a display switching process according to a second embodiment of the present invention, which is performed by the image display device 1. A process for scroll operation is described below. Assuming that a part of a color image is displayed in a display screen of the image display device as shown in FIG. 7, the drawing window is scrolled by the input operating unit 105 from a top left portion of an image on a screen shown in FIG. 7 to the right portion of an image on a screen shown in FIG. 8.

The display switching unit 101 determines whether the image-display switching request information is issued as an operation instruction from a user (Step S301). When the operation instruction (the image-display switching request information) is not issued (No at Step S301), the display switching unit 101 awaits the operation instruction (the image-display switching request information).

When the operation instruction (the image-display switching request information) is issued (Yes at Step S301), the display switching unit 101 changes display condition information for performing image display so that display switching (in this example, scrolling to the right portion of an image) instructed by the operation instruction (the image-display switching request information) is performed (Step S302). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. The changed information is sent as the request information to the acquiring unit 102 and used for acquiring code data.

The acquiring unit 102 determines whether there is missing data that need to be acquired to perform display-mode switching with image data of a currently-displayed image (Step S303). A determination whether there is missing data can be made by, for example, determining whether data in the area specified by drawing-window specifying information is color data, luminance data, or data of default value. Other determination methods are also applicable. In this example, the drawing window is scrolled to the right. Therefore, it is determined that there is the missing data because data of the right portion of the image shown in FIG. 8 is missing (Yes at Step S303). Then, process control proceeds to Step S304.

The acquiring unit 102 acquires, as the missing data, the luminance/color-difference data of an image (a part of the entire image) to be displayed in the drawing window from the data storing unit 1041 based on the request information (Step S304). The expanding unit 1031 expands acquired data and the converting unit 1032 performs color conversion on expanded data (Step S305). Then, the data storing unit 1041 stores therein color-converted data (Step S306). That is, the data storing unit 1041 stores data of the top left portion of the screen shown in FIG. 7 at Step S306. Then, the mode storing unit 1042 stores mode of the data (in this example, color mode) (Step S307).

The display unit 107 displays an image of the color-converted data in the drawing window (Step S308). Thus, the drawing window is scrolled from the top left portion of the color image shown in FIG. 7 to the right portion of the color image as shown in FIG. 8. Even when the drawing window is scrolled to the left as shown in FIG. 9, expansion processing is not required because data of the image part that has been displayed is stored.

Next, a process for switching to the monochrome mode is described below. Assuming that a part of a color image is displayed in the drawing window of the display device as shown in FIG. 7. In this state, display-mode switching operation to the monochrome mode is performed by the input operating unit 105 so that the color image shown in FIG. 7 is switched to a monochrome image shown in FIG. 10.

The display switching unit 101 determines whether the image-display switching request information is issued as an operation instruction from a user (Step S301). When the operation instruction (the image-display switching request information) is not issued (No at Step S301), the display switching unit 101 awaits the operation instruction (the image-display switching request information).

When the operation instruction (the image-display switching request information) is issued (Yes at Step S301), the display switching unit 101 changes display condition information for performing image display so that display switching (in this example, switching to the monochrome mode) instructed by the operation instruction (the image-display switching request information) is performed (Step S302). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. The changed information is sent as the request information to the acquiring unit 102 and used for acquiring code data.

The acquiring unit 102 determines whether there is missing data that need to be acquired to perform display-mode switching with image data of a currently-displayed image (Step S303). Upon switching from the color mode to the monochrome mode, switching to the monochrome mode can be performed by converting color data into luminance/color-difference data and then extracting only the luminance data. Therefore, missing data is not present. On the other hand, upon switching from the monochrome mode to the color mode, color-difference data is missing and need to be acquired.

A determination whether there is missing data can be made by, for example, determining whether data in the area specified by drawing-window specifying information is color data, luminance data, or data of default value. Other determination methods are also applicable. In this example, it is determined that the missing data is not present because the display mode is switched from the color mode to the monochrome mode (No at Step S303). Then, process control proceeds to Step S309.

Specifically, the converting unit 1032 performs color conversion on bitmap data (Step S309). The color conversion is performed such that the color data is converted into the luminance/color-difference data and only the luminance data is extracted. The mode storing unit 1042 stores mode of the data (in this example, monochrome mode) (Step S307). The display unit 107 displays an image of the converted data in the drawing window (Step S308). Thus, the monochrome image shown in FIG. 10 is displayed.

A process for scroll operation is described below. Assuming that a part of a monochrome image is displayed in the drawing window of the display device as shown in FIG. 10. In this state, the drawing window is scrolled by the input operating unit 105 from a top left portion of an image on a screen shown in FIG. 10 to the right portion of an image on a screen shown in FIG. 11.

The display switching unit 101 determines whether the image-display switching request information is issued as an operation instruction from a user (Step S301). When the operation instruction (the image-display switching request information) is not issued (No at Step S301), the display switching unit 101 awaits the operation instruction (the image-display switching request information).

When the operation instruction (the image-display switching request information) is issued (Yes at Step S301), the display switching unit 101 changes display condition information for performing image display so that display switching (in this example, scrolling to the right portion of an image) instructed by the operation instruction (the image-display switching request information) is performed (Step S302). The acquiring unit 102 determines whether there is missing data that need to be acquired to perform display-mode switching with image data of a currently-displayed image (Step S303). In this example, the drawing window is scrolled to the right. Therefore, it is determined that there is the missing data because data of the right portion of the image shown in FIG. 11 is missing (Yes at Step S303). Then, process control proceeds to Step S304.

The acquiring unit 102 acquires, as the missing data, the luminance data of an image (a part of the entire image) to be displayed in the drawing window from the data storing unit 1041 based on the request information (Step S304). The expanding unit 1031 expands acquired data (Step S305). Then, the data storing unit 1041 stores expanded data (Step S306). That is, the data storing unit 1041 stores data of an image displayed in the screen shown in FIG. 10 at Step S306. Then, the mode storing unit 1042 stores mode of the data (in this example, monochrome mode) (Step S307).

The display unit 107 displays an image of the color-converted data in the drawing window (Step S308). Thus, the drawing window is scrolled from the top left portion of the monochrome image shown in FIG. 10 to the right portion of the monochrome image as shown in FIG. 11. Even when the drawing window is scrolled to the left portion of an image as shown in FIG. 12, expansion processing is not required because data of the image part that has been displayed is stored.

As described above, the image display device 1 can perform image display processing at high processing speed by expanding only an image part to be displayed in the drawing window. Furthermore, the image display device 1 can handle a display-mode switching operation and a zooming operation. Therefore, it is possible to display an image without mixing a monochrome part and a color part in the drawing window even when scroll operation or display-mode switching operation between the color mode and the monochrome mode is performed.

In the above example, the display-mode switching is performed on an image that is displayed in the drawing window of the image display device 1 as shown in FIGS. 7 to 12. However, the same display-mode switching can be performed to an image in a size smaller than the size of the drawing window.

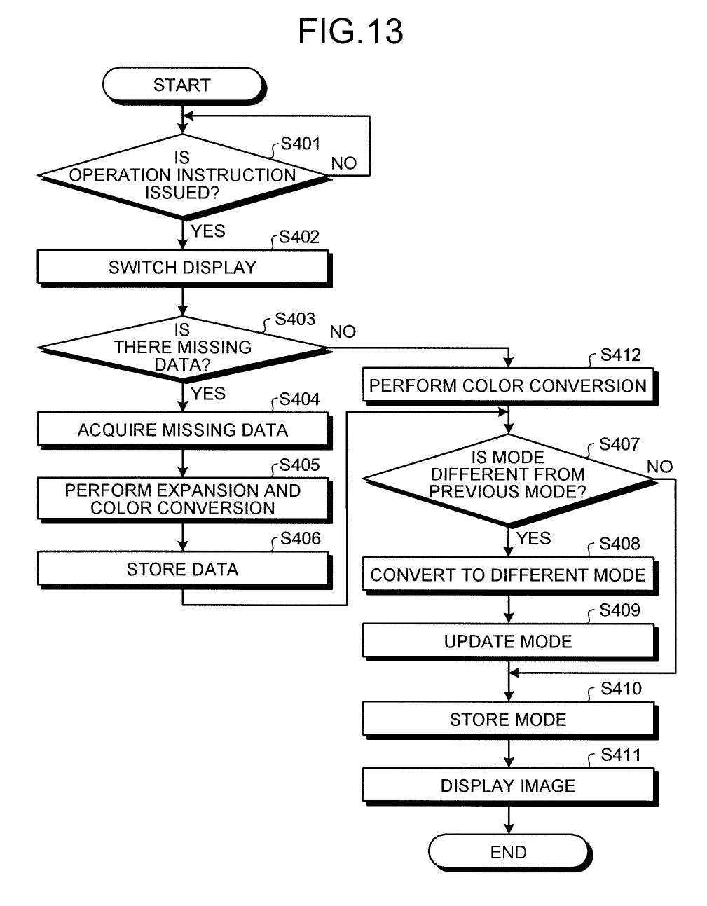

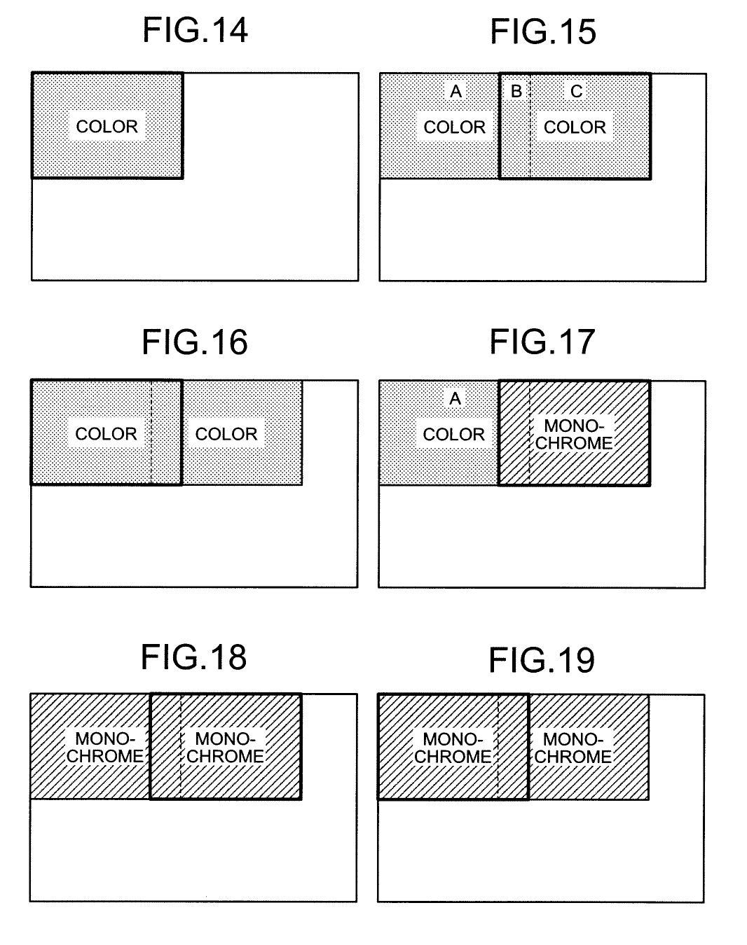

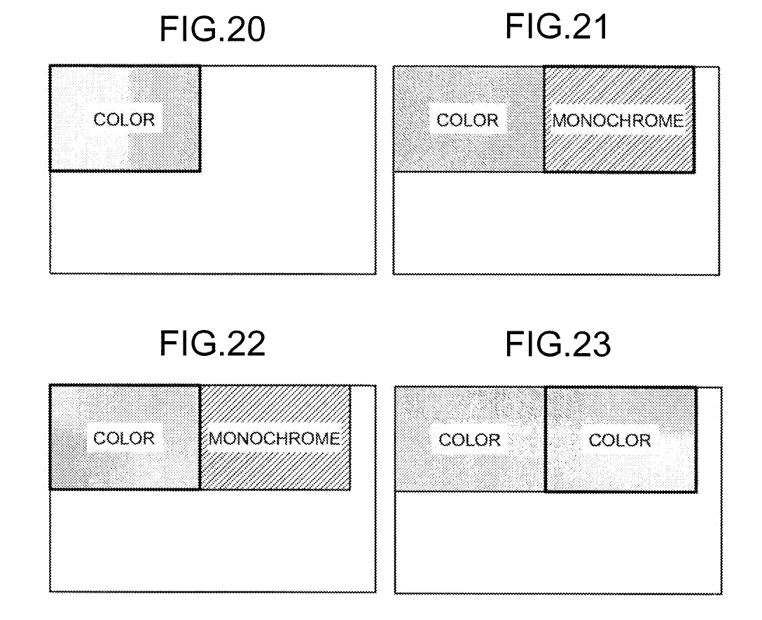

FIG. 13 is a flowchart of a display switching process according to a third embodiment of the present invention, which is performed by the image display device 1. A process for scroll operation is described below. Assuming that a part of a color image is displayed in a display screen of the image display device as shown in FIG. 14. In this state, the drawing window is scrolled by the input operating unit 105 from a top left portion of an image on a screen shown in FIG. 14 to the right portion of an image on a screen shown in FIG. 15. At this time, it is assumed that a part (area B) of an image (portion shown in FIG. 14) that has been displayed is re-displayed in a scrolled display window.

The display switching unit 101 determines whether the image-display switching request information is issued as an operation instruction from a user (Step S401). When the operation instruction (the image-display switching request information) is not issued (No at Step S401), the display switching unit 101 awaits the operation instruction (the image-display switching request information).

When the operation instruction (the image-display switching request information) is issued (Yes at Step S401), the display switching unit 101 changes display condition information for performing image display so that display switching (in this example, scrolling to the right portion of an image) instructed by the operation instruction (the image-display switching request information) is performed (Step S402). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. The changed information is sent as the request information to the acquiring unit 102 and used for acquiring code data.

The acquiring unit 102 determines whether there is missing data that need to be acquired to perform display-mode switching with image data of a currently-displayed image (Step S403). A determination whether there is missing data can be made by, for example, determining whether data in the area specified by drawing-window specifying information is color data, luminance data, or data of default value. Other determination methods are also applicable. In this example, the display window is scrolled to the right portion of an image is performed. Therefore, it is determined that there is the missing data because data of the right portion (area C) of the image shown in FIG. 15 is missing (Yes at Step S403). Then, process control proceeds to Step S404.

The acquiring unit 102 acquires, as the missing data, the luminance/color-difference data of an image (a part of the entire image) in the right portion (area C) shown in FIG. 15 from the data storing unit 1041 based on the request information (Step S404). The expanding unit 1031 expands acquired data and the converting unit 1032 performs color conversion on expanded data (Step S405). Then, the data storing unit 1041 stores color-converted data (Step S406). That is, the data storing unit 1041 stores data of an image displayed in the drawing window shown in FIG. 14 at Step S306.

Then, the converting unit 1032 determines whether a mode of a color-converted data is different from a mode of data of before color conversion (Step S407). When it is determined that the display modes are different from each other (Yes at Step S407), process control proceeds to Step S408. When it is determined that the display modes are the same (No at Step S407), process control proceeds to Step S410.

In this example, it is determined that the display modes are the same because both the display modes are the color modes (No at Step S407). The mode storing unit 1042 stores the display mode (in this example, color mode) (Step S410). The display unit 107 displays an image of the color-converted data in the drawing window (Step S411). In this state, even when the drawing window is scrolled to the left portion of an image as shown in FIG. 16, expansion processing is not required because data of the image part that has been displayed is stored.

A process for switching a color image displayed in the drawing window as shown in FIG. 15 to a monochrome image displayed as shown in FIG. 18 is described below.

The display switching unit 101 determines whether the image-display switching request information is issued as an operation instruction from a user (Step S401). When the operation instruction (the image-display switching request information) is not issued (No at Step S401), the display switching unit 101 awaits the operation instruction (the image-display switching request information).

When the operation instruction (the image-display switching request information) is issued (Yes at Step S401), the display switching unit 101 changes display condition information for performing image display so that display switching (in this example, switching to the monochrome mode) instructed by the operation instruction (the image-display switching request information) is performed (Step S402). Specifically, information on image name of (image.jp2), image size of (m, n), and drawing window specification information (image frame size of (fx, fy), drawing area size of (sx, sy), and drawing area offset of (0x, 0y)) is changed based on the operation instruction (the image-display switching request information) from the user. The changed information is sent as the request information to the acquiring unit 102 and used for acquiring code data.

The acquiring unit 102 determines whether there is missing data that need to be acquired to perform display-mode switching with image data of a currently-displayed image (Step S403). Upon switching from the color mode to the monochrome mode, switching to the monochrome mode can be performed by converting color data into luminance/color-difference data and then extracting only the luminance data. Therefore, missing data is not present. On the other hand, upon switching from the monochrome mode to the color mode, color-difference data is missing and need to be acquired. In this example, it is determined that the missing data is not present because the display mode is switched from the color mode to the monochrome mode (No at Step S403). Then, process control proceeds to Step S412.

Specifically, the converting unit 1032 performs color conversion on bitmap data (Step S412). The color conversion is performed such that the color data is converted into the luminance/color-difference data and only the luminance data is extracted. Then, the converting unit1032 determines whether a mode of a color-converted data is different from a mode of data of before color conversion (Step S407). In this example, it is determined that the display modes are different from each other because the display mode is switched from the color mode to the monochrome mode (No at Step S407). Then, process control proceeds to Step S408.

The converting unit 1032 converts the display mode to a different mode (Step S408). As shown in FIG. 17, the area C of the image portion that has been displayed is in the color mode. Therefore, the image portion is also subjected to color conversion from the color mode to the monochrome mode. The color conversion from the color mode to the monochrome mode is performed such that the color data is converted into the luminance/color-difference data and then only the luminance data is extracted. The mode storing unit 1042 updates the display mode (Step S409). In this example, the display mode is updated from the color mode to the monochrome mode. That is, the mode storing unit 1042 updates the display mode that has been displayed in the drawing window of before display-mode switching to the display mode of after display-mode switching.

The mode storing unit 1042 stores the display mode (in this example, color mode) (Step S410). The display unit 107 displays an image of the color-converted data in the drawing window (Step S411). Thus, the image part that has been displayed can be displayed in the monochrome mode as shown in FIG. 19. In this state, even when the drawing window is scrolled to the left portion of an image is as shown in FIG. 19, expansion processing is not required because data of the image part that has been displayed is stored.

According to an embodiment of the present invention, the image display device can perform image display processing at high processing speed by expanding only an image part to be displayed in the drawing window. Furthermore, the image display device can handle a display-mode switching operation and a zooming operation. Therefore, it is possible to display an image without mixing a monochrome part and a color part in the drawing window even when scroll operation or display-mode switching operation between the color mode and the monochrome mode is performed.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An image display device to display at least a part of an image in a drawing window, the image display device comprising:
a first data storing unit to store therein first data required for displaying the image in the drawing window;
a mode switching unit to switch a display mode in the drawing window;
a data acquiring unit to acquire, upon the mode switching unit switching the display mode, auxiliary data required for displaying the image in a switched display mode in the drawing window from the first data storing unit;
a data generating unit to generate image data required for displaying the image in the switched display mode in the drawing window using the auxiliary data acquired by the data acquiring unit; and
a displaying unit to display thereon the image in the switched display mode in drawing window using the image data generated by the data generating unit.

2. The image display device according to claim 1, further comprising:
a mode storing unit to store therein a first display mode that is a display mode before switching the display mode and a second display mode that is the switched display mode after switching the display mode; and
a second data storing unit to store therein second data that is data required for displaying the image in the first display mode.

3. The image display device according to claim 2, further comprising:
a data converting unit to convert the second data into the auxiliary data; and
an updating unit to update the first display mode stored in the mode storing unit to the second display mode.

4. The image display device according to claim 1, wherein the display mode includes a color mode and a monochrome mode.

5. The image display device according to claim 1, wherein the data generating unit generates the image data by either one of an expansion processing and a color conversion processing on bitmap data.

6. A method of displaying at least a part of an image in a drawing window, the method comprising:
acquiring, upon a mode switching unit switching a display mode in the drawing window, auxiliary data required for displaying the image in a switched display mode in the drawing window from a data storing unit that stores therein data required for displaying the image in the drawing window;
generating image data required for displaying the image in the switched display mode in the drawing window using the auxiliary data acquired at the acquiring; and
displaying the image in the switched display mode in drawing window using the image data generated at the generating.
